(19) United States
(12) Patent Application Publication
(10) Pub. No.: US 2014/0108978 A1
(43) Pub. Date: Apr. 17, 2014

(54) System and Method For Arranging Application Icons Of A User Interface On An Event-Triggered Basis

(71) Applicant: AT&T MOBILITY II LLC, Atlanta, GA (US)

(72) Inventors: Loc Yu, Seattle, WA (US); Jun Shen, Redmond, WA (US)

(73) Assignee: AT&T MOBILITY II LLC, Atlanta, GA (US)

(21) Appl. No.: 13/652,158

(22) Filed: Oct. 15, 2012

(51) Int. Cl. G06F 3/0482

(52) U.S. Cl. CPC G06F 3/0482
USPC 715/765

(57) ABSTRACT

A device, tangible computer readable storage medium and method for detecting a weight adjustment event, selecting one displayable object from a plurality of displayable objects based on the weight adjustment event, adjusting a current weight associated with the one displayable object to a new weight and determining a location on a display screen for the one displayable object based on the new weight.

### BACKGROUND

Tablet computers, smartphones, and other similar devices permit users to download large amounts of software applications, colloquially know as “apps.” Each app can be uniquely represented as an icon on the device screen. If the user has downloaded more apps than can be displayed together on the screen at one time, excess app icons are kept in “virtual space.” That is, though not displayed, the excess app icons are kept in memory, to be summoned for display on the screen in response to a user command. For instance, in a tablet with a touch screen, a default first display screen page is assigned a predetermined number of icons. Any remaining icons not assigned to the first page are assigned to any of a plurality of subsequent display screen pages kept in virtual space. A user swiping his finger across the screen will sweep out the current page of app icons and sweep in from virtual space a new page of app icons. In this static mode of displaying app icons, they are typically arranged in the order in which they were downloaded, so that a user must swipe the screen several times to move from the oldest apps to the newest ones. A user can change this static display order only in a cumbersome manner by manually adjusting the display locations of individually selected app icons. For instance, in a tablet like the iPad®, app icons are assigned to display screen pages. The tablet defaults to the first display screen page whenever the tablet is turned on or upon exiting a currently executed app. To relocate an app icon to the default first screen page from its currently assigned display screen page, a user points and drags the app icon to the edge of the display screen and holds it there in order to prompt the tablet to consecutively sweep through the display screen pages until the first one is displayed, at which point the user can further drag the app icon to a desired location in the first display screen page. Once released by the user, the app icon is assigned to the first display screen page.

At a certain point, the amount of downloaded apps becomes so large that the user no longer can effectively track all the apps stored on the device. Frustration can mount as the user repeatedly cycles back and forth among the multitude of app icons until the desired one is found. Moreover, since a user who stores a voluminous amount of apps will not be able to remember them all, opportunities to use them may slip by unnoticed. For example, a user who finds himself in a new city would naturally want to find a good restaurant, but will miss the chance to use a restaurant finder app if he forgets that it is on his device.

### SUMMARY OF THE INVENTION

A method for detecting a weight adjustment event, selecting one displayable object from a plurality of displayable objects based on the weight adjustment event, adjusting a current weight associated with the one displayable object to a new weight and determining a location on a display screen for the one displayable object based on the new weight.

A tangible computer readable storage medium including a set of instructions. The set of instructions causing a processor to perform a method for detecting a weight adjustment event, selecting one displayable object from a plurality of displayable objects based on the weight adjustment event, adjusting a current weight associated with the one displayable object to a new weight and determining a display screen location for the one displayable object based on the new weight.

A device having a display screen to display a plurality of displayable objects, a memory to store a set of instructions and a processor to execute the instructions to perform a method for detecting a weight adjusting event and selecting one of the plurality of displayable objects on the basis of the weight adjusting event, adjusting a current weight of the one displayable object to a new weight, and determining a display screen location for the one displayable object on the basis of the new weight.

### BRIEF DESCRIPTION OF THE DRAWINGS

FIG. 1 is a diagram showing a display screen that, in response to a detectable event, transitions from a first state displaying a first set of app icons to a second screen state displaying a second set of app icons.

FIG. 2 shows a flow diagram of the weight adjustment feature of the exemplary embodiments.

FIG. 3 illustrates a system diagram for performing the weight adjustment process of the exemplary embodiments.

FIG. 4 shows an exemplary display mode for facilitating access to apps.

### DETAILED DESCRIPTION

The exemplary embodiments may be further understood with reference to the following description and the appended drawings, wherein like elements are referred to with the same reference numerals. The exemplary embodiments describe methods and systems for rearranging displayable icons on the basis of detectable events, in order to ensure that the icons of the apps most pertinent to the detected event are the ones displayed most conspicuously to ensure notice by the user.

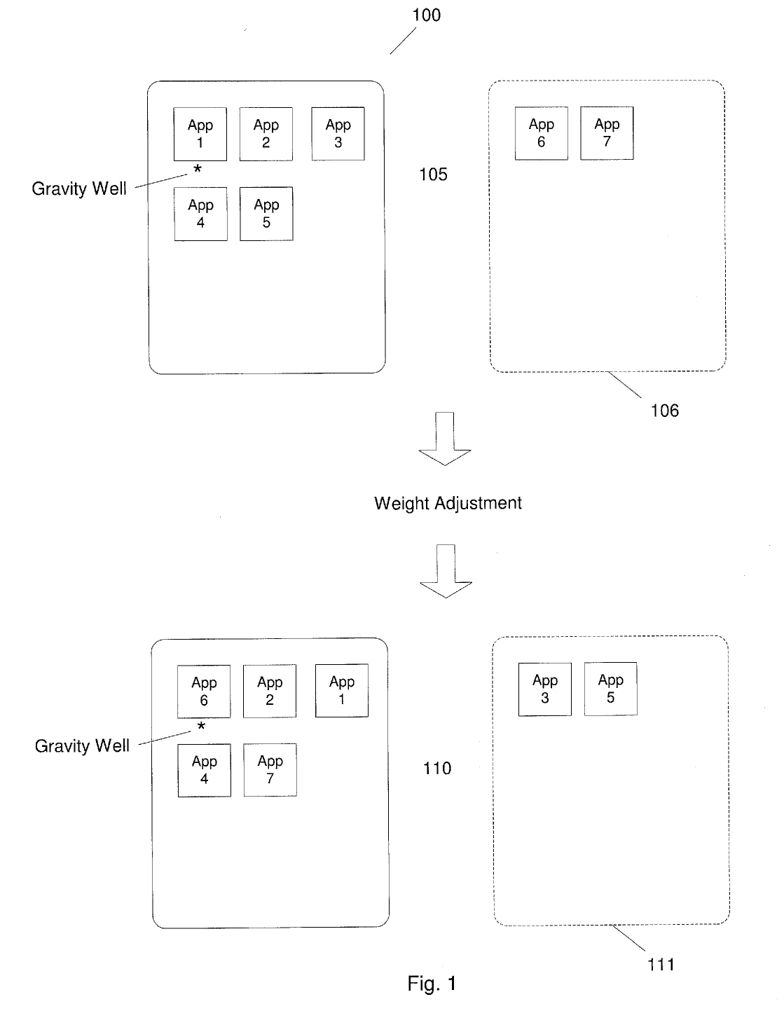

FIG. 1 is a diagram showing a display screen 100 that, in response to a detectable event, transitions from a first state 105 displaying a first set of app icons to a second screen state 110 displaying a second set of app icons, which may include some of the first set icons rearranged in a different order. For instance, FIG. 1 may represent the default display screen page transitioning between these two states. The dotted line representations 106, 111 represent a virtual space corresponding to those app icons that are stored on the device but are not currently displayed.

The specific mechanism for accomplishing this transition assigns to each app at downloading a particular initial value, called a weight, and adjusts the weight of one or more app icons when a detectable event is detected. Although the embodiments described herein are illustrated by reference to app icons, the embodiments are also relevant to other types of displayable objects. After the weight adjustment is done, the app icons are reshuffled on the screen so that the “heavier” icons (i.e., those with larger weights) are displayed closer to a “gravity well” GW which is a designated point on the screen, typically the most conspicuous (e.g., the top left corner of the screen). The gravity well location on the screen may be preprogrammed into the device, automatically adjusted by the device, or adjusted manually by the user. A weight adjustment event need not change the weight of every icon, although it could; in some instances a weight adjustment event may affect only one or two icons. Thus, certain weight adjustment events will change the display locations of only a small number of app icons. The weight adjustment mechanism allows apps that are rarely used to nevertheless assume a conspicuous screen location when detectable conditions occur that are pertinent to the capabilities of the app. The following describes several examples illustrating the weight adjustment mechanism of the described embodiments.

Frequency of Usage—The weight depends on the frequency that an app is used. For example, each time an app is used, its weight value is increased by a predetermined amount. According to this embodiment, the most frequently used app is associated with an app icon having the heaviest weight, which means that this icon is either on or nearest to the gravity well on the display screen. The next heaviest app icon is displayed in the next closest location to the gravity well, etc. Thus, if an app becomes the most frequently used app, its icon replaces the icon of the former most frequently used app at the gravity well location. Similarly, if the third most frequently used app becomes the second most frequently used app, then its icon is relocated to the display screen location of the former second most frequently used app. An alternative way that the system and method of the present application can account for frequency of usage is to set each app to a predetermined weight when the app is first instantiated, downloaded, or preloaded. Then, each day (or any other period of time) that the app is not used will cause the system to decrease the predetermined weight by a certain value. Each time the app is used, its weight is increased by the same value or a different value. The weight may be prohibited from exceeding a maximum value.

Date Weight—The particular weight assigned to an app icon may depend on the date of the year. For instance, as April 15^{th} approaches, a tax preparation app icon may have its weight increased on a daily basis until a maximum value on April 16^{th}, so that the icon progressively moves closer to the gravity well on the display screen. On April 16^{th} the app icon weight may be changed to a minimum value, so that the icon is pushed away from the gravity well, reflecting the understanding that, for those who filed their returns on time, the tax preparation app no longer is of significant relevance. Different apps may react to different dates of the year. For instance, a shopping app may have its icon weight adjusted upwardly as Christmas approaches, or a religious app may have its icon shift toward the gravity well on the eve of a religious holiday.

Time Weight—Certain apps ought to have their icons displayed more conspicuously depending on the time of day. For instance, an alarm app icon ought to increase in weight at night, so that the user does not neglect to set or change the alarm for the next morning. As dinner-time approaches, an icon for a recipe app may be shifted toward the gravity well.

Fixed Location Weight—Certain apps are pertinent only when a user is at a particular location. For instance, the relevance of a spreadsheet app typically is at its maximum when the user is at work. Using, for example, the GPS capability that is typical in many tablets and smartphones, the device may increase the weight of the spreadsheet app icon, and cause it to appear at or near the gravity well screen location, while the user is at work. Once the user leaves for home, and the device detects that it no longer is at the location associated with the user's place of work, the weight value of the spreadsheet app icon is accordingly reduced, causing it to shift to a more remote display screen location relative to the gravity well.

Relative Location Weight—Certain apps become more relevant to a user depending on the relative distance between the device of the user and some other entity (e.g., a device belonging to another person). For example, if the device of the user is able to detect (through conventional GPS or triangulation-based location services) the location of the device of a family member, then the weight of family-relevant apps (as selected or determined by the individuals involved, or as selected or determined through some predetermined criteria) will be adjusted depending on the relative distance between the devices. This relative weight feature may be triggered, for instance, only if the two or more related devices (e.g., the devices belonging to all members of a family) are within a maximum range, so that, for instance, the weight adjustment based on relative location weight is activated only if the devices are within a mile of each other.

Velocity Weight—If a device is equipped with the ability to calculate the velocity at which it is moving, it may use this information to adjust app icon weights. For instance, if the device is moving faster than forty miles per hour, icons relating to navigation or travel apps may have their weights increased in order to make them more easily accessible on the display screen.

Physical Trigger—Certain detectable events may trigger a weight adjustment. For instance, if the device detects that a headset or a Bluetooth® device has been attached, the detection will trigger a weight adjustment of music or video apps that will draw them to or near the gravity well.

Associated Weight—Since certain apps are related to each other, a detected event ought to trigger the same weight adjustment to all their icons. For instance, in the example described above pertaining to work-related apps, a device may typically store two or more apps, like spreadsheet and email apps, that a user would wish to be prominently displayed while at work. To actuate this associated weight feature, the device may permit the user to enter a command linking selected apps so that any weight adjustment is concomitantly made to the linked apps. As a result, when the device is at work, the spreadsheet and email app icons are the closest app icons to the gravity well.

Promotion Weight—Certain retailers interact with customers through their tablets or smartphones. When a customer walks into a retail location, the retailer may wish to persuade the user to activate the retailer's app while present at the retail location, in order to take advantage of certain sales or become aware of new products through the app. For instance, a retail bookseller that also provides its own device app may want to ensure that its own app is conspicuously displayed on a user device while the user is present at the bookseller's store location, in order to use the app to notify the user of new books that are pertinent to the user's buying history. Using a locator service like GPS, the device may determine that it is at a retailer location, at which point it may increase the weight of the retailer-related app to a value that shifts the app icon to or near the gravity well. Once the device detects that it no longer is at the retailer, the device reduces the weight of the retailer app to its former value, thereby returning the app icon to its former location farther away from the gravity well.

User Targeting Weight—This feature enables a device to learn the app usage pattern of a user over time, and to autonomously set weight adjustment values in accordance with the learned pattern. For instance, if the device detects over a period of time (e.g., a week or a month) that a user periodically checks a weather app as he leaves work at 6:00 PM, then the device will adjust the weight for that app so that it appears at or near the gravity well at that time. The device may even be enabled to learn usage patterns and perform such adjustments on a day-of-the-week basis as well, so that the weather app is prominently displayed at 6:00 PM only during the work week, and the adjustment is suspended during the weekend, since the device learns that the 6:00 PM weather check is hardly ever selected by the user on Saturdays or Sundays.

In the examples of weight adjustment described above, one or more functions of the device external to the apps themselves triggered a weight adjustment operation for one or more apps. That is, the GPS module of the device triggered an adjustment of the app icons relating to work or retailers, while the clock module adjusted the screen location of an alarm app. A weight adjustment can also be prompted by the activity of an app itself. In this sort of weight adjustment, the activity of one app affects the weight of other apps. For example, if a user has activated a stock trading app, the activity of this app increases the weight of other financial apps, so that the icons of these other financial apps are shifted to or toward the gravity well so long as the stock trading app remains active.

The weight adjustment functions described above involve automatically adjusting the weights of app icons. Nevertheless, a weight adjustment can be performed manually by a user. Specifically, the user may manually select an app icon and input a desired weight value for the selected icon, after which the device relocates the app icon on the display screen in accordance with the manually input weight.

The activity of one app may reduce, instead of increase, the weight of other apps. If a user has activated an exercise app, the weights of food or cooking apps may be reduced. In another example, if a child of a device owner is using a toddler-related app, that may prompt a reduction in the weight of work-related apps, thereby repelling these apps away from the gravity well and ensuring that the child will not accidentally activate the work-related apps.

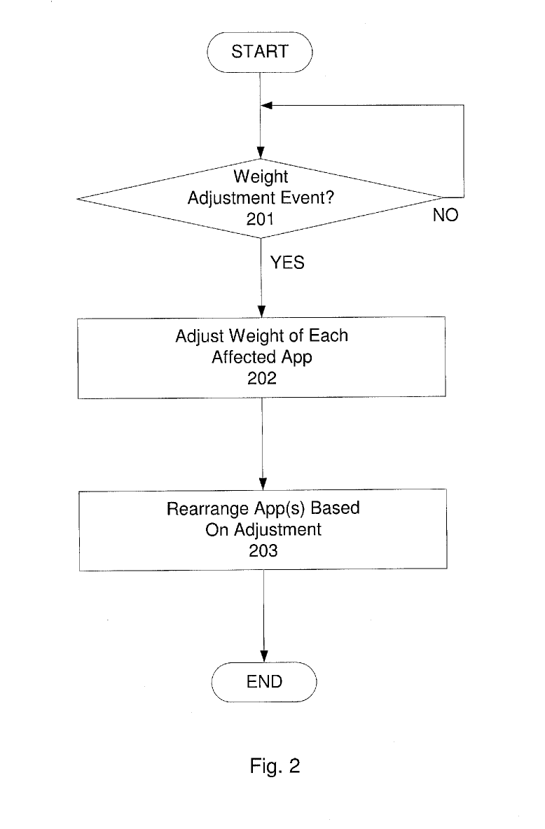

FIG. 2 shows a flow diagram of the weight adjustment feature of the present embodiments. The device determines whether a weight adjustment event has been detected. (Step 201). For instance, the GPS module of the device may determine that the device is at the work office of the user, or the clock module may determine that the current date is Christmas Eve. Alternatively, as explained above, the weight adjustment event may not be an external factor, but the activity of a particular app, as when, for example, a stock trading app begins pulling stock price information from an information source.

If a weight adjustment event has been detected, the method of the present embodiments determines which app icons require adjustment to their weights, and the amount of such adjustment. (step 202). Not every app icon need have its weight adjusted when a weight adjustment event is detected. For instance, if the detection of the weight adjustment event is determined by the GPS module (instead of, for example, by the calendar module), then only the travel-related apps will have the weights of their icons adjusted. The device memory may be programmed to associate each app icon with each category of weight adjustment event that would require a weight adjustment event. For instance, the device may be programmed to adjust the weight of hotel and restaurant finder app icons in reply to the output of the GPS module, whereas the device may be programmed to associate the weight adjustment of a tax prep app icon with the calendar functionality of the device. This association ensures that app icons are adjusted only in response to detected events that are pertinent to the purposes of their associated apps. When the GPS module determines that the device is at a particular location (e.g., a city away from the home city of the user, which would also be pre-programmed into the device), it will look up which apps are associated with the GPS function. Having determined that the hotel and restaurant finder apps are associated with the GPS function, the device will look up the current weight values of the respective icons, and then determine an adjustment amount that is either a pre-fixed amount, or in proportion to a distance from a particular reference point (e.g., the closer the device is to the user home city, the less the amount of the weight adjustment to the hotel and restaurant finder app icons). Moreover, the weight adjustment may be an increase or a decrease. For instance, in the case where the GPS module of the device determines that it is at the work office of the user (the device having been previously programmed by the user to recognize and identify the geospatial coordinates of his building as his work office), the device will increase the weights of all work-related apps (as previously identified to the device by the user). As a result, the icons of work-related apps will tend to be drawn toward the gravity well on the display screen, making them more noticeable and more easily accessible to the user. Once the user leaves work, the device will recognize that it no longer is at work, and so will reduce the weights of the work-related app icons accordingly, thereby causing them to recede away from the gravity well location on the device screen.

The amount of the weight adjustment may be preset in memory to a constant amount, or it may be proportional to some characteristic of the detected weight adjustment event. In the case of a holiday, the amount of the weight adjustment to the icons of holiday-related app icons may be a preset amount (although the device may be programmed to increase the weight of app icons related to major holidays more than the weight of app icons related to less significant holidays). In the case of velocity triggering a weight adjustment to navigation app icons, the amount of the weight adjustment may be greater as the detected velocity increases. For instance, a detected velocity between 45 and 65 mph may trigger a weight adjustment to navigation app icons that is twice the weight adjustment that would result for a speed between 25 and 44 mph.

Once the device has adjusted the weights of the app icons associated with the detected event, it reorders the appearance of the app icons on the device screen, as seen in FIG. 1. (Step 203). One criteria for determining the display order is based on the relative magnitudes of the weights of the app icons. For instance, if the device detects that it is outside of the home city of the user and increases the weight of the travel-related app icons accordingly, it will compare the adjusted weights to the weights of the other app icons and rank them by magnitude. If the augmentation to the weight of the travel-related app icons causes them to become the “heaviest” icons, the device will relocate them at the gravity well, and those app icons that formerly were at the gravity well are placed farther away. In contrast, if the device returns to the home city of the user, then the device will reduce the weights of the travel-related app icons to a smaller amount, so that the device relocates them away from the gravity well.

One exception to the above-described dynamic weight adjustment scheme is anchoring. If a user wishes to exempt a particular app icon from having its location dynamically determined, the user may enter a command (e.g., perform a particular gesture on a touch screen, such as by holding the selected icon at a desired location) that the device interprets as the permanent location for that icon, unalterable by the dynamic weight adjustment mechanism of the described embodiments. Once an app icon is anchored at a specific display screen location, it remains there indefinitely, and the dynamic display screen reallocation scheme skips this location when reassigning app icons to new screen locations.

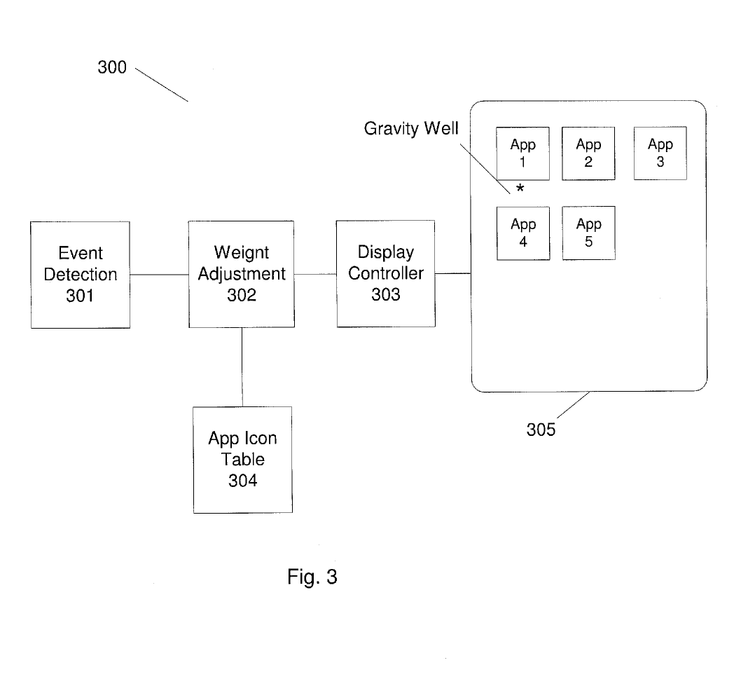

FIG. 3 illustrates a system diagram for performing the weight adjustment process described above. In the case of a tablet, smartphone, or other similar device, the system 300 may be implemented by the processing and storage components of the device, suitably programmed to perform the various functionalities described above. The system 300 of FIG. 3 includes an event detection module 301 that determines when an event has occurred that warrants adjusting the weight of one or more app icons. The event detection module 301 receives, for example, signals produced by the GPS, calendar, and velocity determination functions residing on the device. Module 301 also is capable of monitoring the activities of the apps for weight adjusting events, as in the case described above where the activity of a stock trading app triggered the weight adjustment of a plurality of financial app icons. Once a particular weight adjustment event has been detected by event detection module 301, weight adjustment module 302 determines, in the manner described before, which app icons require weight adjustment and the magnitude of such adjustments. In aid of this determination, weight adjustment module 302 may consult app icon table 304. App icon table 304 may store information associating particular weight adjustment events with specific app icons, and it may also store the particular weight adjustment amounts or formulas for each weight adjustment event. For instance, table 304 may associate weight adjustment events detected by the GPS capability with only travel-related apps, so that a particular event detected via the GPS capability of the device (e.g., new city) will initiate a weight adjustment for the app icons of these apps, but not for any other app. The app table 304 may also store a specific magnitude by which the weight of the app icon is to be adjusted, or it may store a formula that adjusts the weight in proportion to a characteristic of the event that has been detected (e.g., distance of new city from home city).

Once the app icons requiring adjustment have been identified, and the magnitudes of their respective weight adjustments have been determined, display controller 303 adjusts the display of the app icons on display screen 303 on the basis these identifications and determinations. For instance, if, after the weight adjustment, app icon 1 is assigned the heaviest weight, then it is relocated to the gravity well GW on the display screen. If the next heaviest app icon is app icon 2, then it is placed next to app icon 1, and so on.

The components of system 300 may be embodied by the processing and storage systems found in tablet computers or smartphones. In the case of a tablet computer, for instance, the event detection and weight adjustment modules 301, 302 may be implemented by the central processor of the device, or by an auxiliary processor dedicated to these functions. Application table 304 may be embodied by the general purpose internal flash memory of the device, or by a separate memory dedicated to storing the data of application table 104.

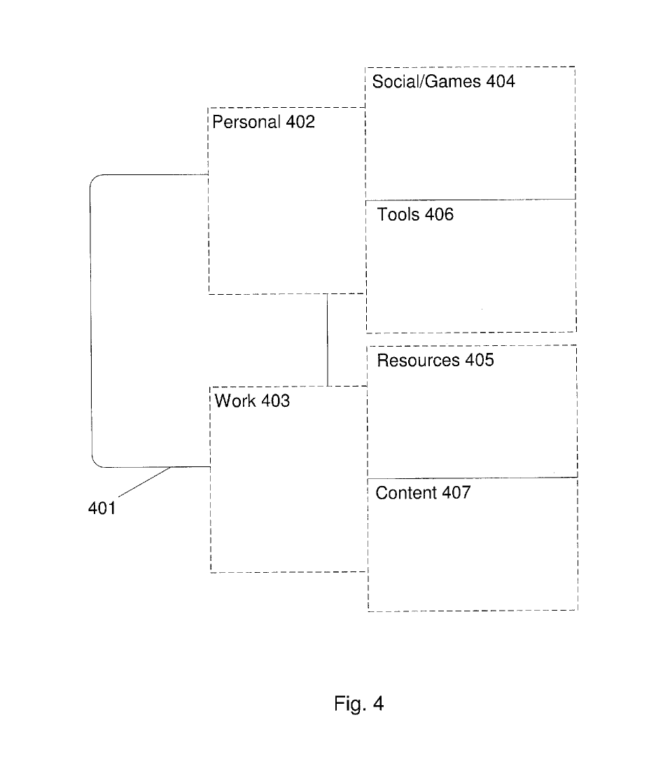

FIG. 4 shows another display mode for facilitating access to apps. Typically, prior devices implement multiple screens for displaying resident app icons. For instance, if a screen can display thirty app icons, but the device stores ninety, then three pages of screens, each displaying thirty icons, are needed. A user can linearly cycle through the app icons from left to right or top to bottom, typically by using finger gestures on a touch sensitive screen. FIG. 4 illustrates a new approach for distributing app icons among multiple screen pages, referred to as binary sub-screens. FIG. 4 shows a physical screen 401 capable of displaying multiple screen pages 402-407. The screen pages 402-407 are arranged hierarchically, so that the personal display screen page 402 is linked with sub-screens 404 and 406 relating to social/game apps and tools, respectively. Similarly, the work screen page 403 is linked to sub-screens 405 and 407 pertaining to work-related resources and content, respectively. The advantage of the binary-subscreen arrangement of FIG. 4 is that a user who wishes to access an app assigned to a certain screen page need not cycle through every preceding page. Instead, for instance, if a user wishes to access a game app, the user can access the personal screen page, and then switch directly through to the social/games subscreen, without having to cycle through on the display the work-related subscreens. In the case of screen 401 having touch-input capabilities, the subscreen embodiment reduces the number of swiping gestures a user must perform in order to arrive at the screen page containing the desired app. Similarly, a user interested in accessing a work-related app need not go through the cumbersome process of repeatedly swiping through every irrelevant screen page between the currently displayed screen page and the one containing the desired work-related app.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A method, comprising:
detecting a weight adjustment event;
selecting one displayable object from a plurality of displayable objects based on the weight adjustment event;
adjusting a current weight associated with the one displayable object to a new weight; and
determining a location on a display screen for the one displayable object based on the new weight.

2. The method of claim 1, wherein the determining includes determining the display screen location for the one displayable object in relation to a gravity well located on the display screen.

3. The method of claim 1, further comprising:
automatically determining a display screen location for the gravity well.

4. The method of claim 1, further comprising:
manually determining a display screen location for the gravity well.

5. The method of claim 1, further comprising:
displaying the one displayable object on the display screen in accordance with the new weight.

6. The method of claim 1, wherein:
the weight adjustment event is a selection of the one displayable object by a user, and
the adjusting of the current weight includes changing the current weight to the new weight corresponding to a value input by the user.

7. The method of claim 1, wherein:
the weight adjustment event includes a predetermined time of day.

8. The method of claim 1, wherein:
the weight adjustment event includes arriving at a distance between a location of a device that includes the display screen and a second location that is detectable by the device, and
the new weight corresponds to a value that depends on the distance.

9. The method of claim 1, wherein:
the weight adjustment event includes a time, and
the new weight corresponds to a value that is dependent on the time.

10. The method of claim 9, wherein the time includes a time of day.

11. The method of claim 9, wherein the time includes a time of month.

12. The method of claim 9, wherein the time includes a time of year.

13. The method of claim 1, wherein:
the weight adjustment event includes arriving at a predefined location.

14. The method of claim 1, wherein:
the weight adjustment event includes a frequency of use of a software application associated with the one displayable object.

15. The method of claim 1, wherein:
the weight adjustment event includes a velocity of the device.

16. The method of claim 2, wherein:
the new weight is higher than the current weight, and
as a result of the higher new weight, the display screen location of the one displayable object is moved closer to the gravity well.

17. The method of claim 2, wherein:
the new weight is lower than the current weight, and
as a result of the lower new weight, the display screen location of the one displayable object is moved farther from the gravity well.

18. The method of claim 1, wherein:
the one displayable object is an app icon of an app residing on a device.

19. A tangible computer readable storage medium including a set of instructions, the set of instructions causing a processor to perform a method, the method comprising:
detecting a weight adjustment event;
selecting one displayable object from a plurality of displayable objects based on the weight adjustment event;
adjusting a current weight associated with the one displayable object to a new weight; and
determining a display screen location for the one displayable object based on the new weight.

20. A device, comprising:
a display screen to display a plurality of displayable objects;
a memory to store a set of instructions; and
a processor to execute the instructions to perform a method, the method comprising,
detecting a weight adjusting event and selecting one of the plurality of displayable objects on the basis of the weight adjusting event,
adjusting a current weight of the one displayable object to a new weight, and
determining a display screen location for the one displayable object on the basis of the new weight.
